(19) United States
(12) Patent Application Publication
(10) Pub. No.: US 2025/0080526 A1
(43) Pub. Date: Mar. 6, 2025

(54) AUTHENTICATING PRESENTED CREDENTIALS OF INDIVIDUALS

(71) Applicant: Lumen Vector LLC, Woods Cross, UT (US)

(72) Inventors: Brett J. Anderson, Woods Cross, UT (US); Kevin L. Anderson, Woods Cross, UT (US)

(21) Appl. No.: 18/593,736

(22) Filed: Mar. 1, 2024

Related U.S. Application Data
(60) Provisional application No. 63/488,496, filed on Mar. 4, 2023.

(51) Int. Cl. H04L 9/40

(52) U.S. Cl. CPC H04L 63/083; H04L 63/0861

(57) ABSTRACT

An authentication system is implemented for authenticating the identity of an entity. By registering and verifying user accounts for entities using the authentication system, the authentication system ensures with high confidence that user accounts are associated with verified entities. Authenticating identities between entities may be established and represented in the authentication system by authenticated identity objects. The entities may access the authenticated identity objects by requesting dynamic tokens linked to the authenticated identity object. A requesting entity can provide the dynamic token to another entity who may then provide the dynamic token back to the authentication system. Based on verifying the dynamic token, the authentication system provides an indication of a verification of the entity. In this way, an entity may rely on the verification prior to further interacting with another entity or individual.

### CROSS REFERENCE TO RELATED APPLICATIONS

This application claims benefit and priority to Provisional Application No. 63/488,496, filed on Mar. 4, 2023, the entirety of which is incorporated herein by reference.

### BACKGROUND OF THE DISCLOSURE

Identity management techniques typically provide authentication of users primarily in digital environments. For instance, many conventional authentication or login solutions are implemented with respect to a user interfacing with a computer system or software application. There exists, however, a need for authenticating the identity, credentials, purpose, etc. of individuals, for example, interacting in the real world. For instance, individuals often interact (e.g., face to face) for the purpose of conducting business, exchanging information, gaining access to facilities, performing services, and myriad other circumstances. Thus, systems and methods for authenticating that individuals are, in fact, who they purport to be may be advantageous.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1A illustrates an example environment in which an authentication system is implemented, according to at least one embodiment of the present disclosure;

FIG. 1B illustrates an example implementation of an authentication system as described herein, according to at least one embodiment of the present disclosure;

FIG. 2 illustrates an overview of the authentication system providing multi-way authentication of users, according to at least one embodiment of the present disclosure;

FIG. 3 illustrates example features of an account manager as described herein, according to at least one embodiment of the present disclosure;

FIGS. 4A and 4B illustrate example implementations of the authentication system as described herein, according to embodiments of the present disclosure;

FIGS. 5A and 5B illustrate example implementations of the authentication system as described herein, according to embodiments of the present disclosure;

FIGS. 6A, 6B, and 6C illustrate example implementations of the authentication system as described herein, according to embodiments of the present disclosure;

FIGS. 7A and 7B illustrate example implementations of the authentication system as described herein, according to embodiments of the present disclosure;

FIG. 8 illustrates a method 800 or a series of acts for authenticating an individual as describe herein, according to at least one embodiment of the present disclosure;

FIG. 9 illustrates a method 900 or a series of acts for authenticating an individual as describe herein, according to at least one embodiment of the present disclosure;

FIG. 10 illustrates a method 1000 or a series of acts for authenticating an individual as describe herein, according to at least one embodiment of the present disclosure; and

FIG. 11 illustrates certain components that may be included within a computing system.

### DETAILED DESCRIPTION

This disclosure generally relates to systems and methods for authenticating the identity of individuals and/or organizations. For example, users may register user accounts with an authentication system. Based on information provided by the users, the authentication system may authenticate or vet that the user accounts are actually associated with the users for which they purport to be associated. The authentication system may periodically update user information and/or require additional user information in order to continually verify the authenticity of the user accounts. Additionally, the authentication system may ensure that individuals that access the user accounts are actually the users for which the user accounts are associated. For example, the authentication system may provide a secure login process and may require the users to provide biometric information as well as a password on a specific registered client device in order to access a user account. In this way, the authentication system may ensure with a high confidence that the users of the authentication system are who they actually claim to be.

Additionally, the authentication system may facilitate authenticating (e.g., real world) interactions between users. For instance, users having trusted, real-world relationships, or authenticated identities, may represent these relationships through authenticated identity objects. The users may have access to the authenticated identity objects by requesting dynamic tokens linked to the authenticated identity objects. By a user presenting a dynamic token to another user in various different circumstances, the identity of the user with respect to another specific user, with respect to an purpose or task of the user, or with respect to an object associated with the user may be verified by the authentication system and an indication of the identity may be provided to one or more users. In this way, users may interact with an increased confidence in the identity of other users based on the authenticated identity objects of the authentication system.

As will be discussed in further detail below, the present disclosure includes a number of practical applications having features described herein that provide benefits and/or solve problems associated with identity authentication. Some example benefits are discussed herein in connection with various features and functionalities provided by an authentication system implemented on one or more computing devices. It will be appreciated that benefits explicitly discussed in connection with one or more embodiments described herein are provided by way of example and are not intended to be an exhaustive list of all possible benefits of the authentication system.

For example, individuals may typically have one or more friends, relatives, neighbors, work associates, or other acquaintances with which the individual has a level of trust. In some cases, however, a bad actor may present themselves to the individual in a setting where the identity of the bad actor may not be readily apparent, and the bad actor can attempt to take advantage of the trust the individual has for these trusted parties by purporting to be one of them. Such scams are commonplace in today's world and it can be difficult to discern with whom one is actually interacting, especially when considering that sensitive information may be readily available for fraudulent actors to convince individuals that they are someone they are not. The authentication system described herein may facilitate individuals confidently authenticating the identity of those with whom the interact. For example, for those parties with which an individual has a level of trust, authenticated identity objects may be created that represent this trust, and these authenticated identity objects may only be accessible to the individual and the trusted party. In order to authenticate that identity of a person with whom an individual is interacting, one (or both) parties may provide an indication of the authenticated identity object (in the form of a dynamic token) in order to validate that the parties are who they say they are (e.g., the parties involved in the creation of the authenticated identity object).

Additionally, these authenticated identity objects representing known or trusted relationships may also be employed for validating identities between parties for which no common authenticated identity object or no trusted relationship exists. For example, providing a dynamic token for an authenticated identity object associated with a mutual 3^{rd} party may serve to authenticate the identity of the individuals' interactions. Further, access to authenticated identity objects may be shared in order facilitate parties representing or acting on behalf of one another in one or more capacities. Thus, the authentication system provides flexibility for adapting to multiple situations while also providing identity authentication with a high level of confidence.

Further, the dynamic tokens for indicating an association with a specific authenticated identity object may be dynamic in nature to provide further layers of security. For example, the dynamic tokens may be expiring such that they are only enabled for a short period of time and/or may be enabled only for use in limited other circumstances. In this way, the dynamic tokens may not be intercepted, spoofed, or otherwise used by malicious parties to feign access to an authenticated identity object. Thus, parties may further rely on the authenticated identity objects with an increased level of confidence in order to authenticate other individuals and carry out real-world interactions with assurance.

As illustrated in the foregoing discussion, this disclosure utilizes a variety of terms to describe the features and advantages of one or more implementations described. To illustrate, this disclosure describes the authentication system in the context of a cloud computing system.

As used herein, the term “identity” and, more specifically, “authenticated identity” refers to an identity of an entity. An entity may be a party, individual, organization, etc., and an identity may refer to a relationship, purpose, task, authorization, etc. of one entity with respect to another entity. For instance, an identity may refer to a relationship, acquaintance, or knowledge of one party with respect to another party. As an illustrative example, a first party may have an identity with respect to second party based on the second party having a personal knowledge of the first party. As another example, a party may have an identity with respect to an organization based on the organization acknowledging that the party is associated with the organization. An entity may have multiple identities. For instance, a party may have an identity as a friend, family member, or acquaintance of another party, and may also have an identity as an employee of an organization. In this way, one or more identities may describe an entity based on its relation to other entities.

An identity may be an “authenticated identity” when it is confirmed, validated, or otherwise authenticated by one or more entities. For example, a party may have an authenticated identity with respect to an organization based on the organization knowing, trusting, or otherwise recognizing the party in their capacity as an employee of the organization. As another example, a first party may have an authenticated identity with respect to a second party when the second party knows, trusts, or otherwise acknowledges that they have a personal relationship with the first party (and/or vice versa). In this way, an authenticated identity may refer to the identity of an entity as known to another entity and as verified or authenticated by that other entity through some real-world means. For example, a party may verify the identity of an entity through a relationship or a personal level of trust of the party with the entity. As another example, a party may verify the identity of an entity through means facilitated by the authentication system as described herein.

As used herein, the term “authenticated identity object” refers to a data or software object that is representative of an authenticated identity of an entity (e.g., a trusted relationship between parties). For example, an authenticated identity object may record, memorialize, or otherwise represent a known identity of one entity with respect to another, as well as that that identity has been confirmed, verified, or otherwise authenticated (e.g., through some real-world means). The authenticated identity object may include, or may be associated with, “identity information” which may include information about the associated identity and/or entity. For example, identity information may include information about an identity of an employee with respect to an organization. As another example, identity information may include information about an identity of a first individual with respect to a second individual. Identity information may include a name, photo, contact information, employment information, permission or authorization information, task or job, purpose, authentication history or rating, or any other information related to one or more entities and an associated identity.

As used herein, a “token” or a “dynamic token” may be used interchangeably to refer to an identifier linked to an authenticated identity object. For example, a token may include a code such as an alphanumeric code, string of numbers and/or letters, binary code, etc. A token may include a Quick Response (QR) code, bar code, image, or other (e.g., scannable) code. A token may include a password or passphrase. A token may include one or more biometrics. A token may include information transmitted, either directly or indirectly, from one device to another such as through near-field communication (NFC), radio frequency identification (RFID), Bluetooth, or a data network such as WiFi or cellular network (e.g., a push notification). In one or more embodiments, a token refers to a combination of the above-objects, or a data object that includes multiple discrete identifiers (e.g., a token including both a QR code and a string of numbers and/or letters). A token (and the form of the token) may be configured to uniquely identify a specific authenticated identity object. For instance, a token, when provided to a client device, may uniquely identify a specific authenticated identity object (e.g., associated with a user of the client device). In some cases, a token may be dynamic, such as an expiring or ephemeral token that is configured to identify an authenticated identity object for only a limited amount of time and/or a token that is enabled for only limited circumstances (e.g., at a specific location). In this way, authenticated identity objects (and associated identity information) may be identifiable and/or accessible through one or more associated dynamic tokens. As described herein, dynamic tokens may be received and/or provided by entities for identifying a specific authenticated identity of the entities.

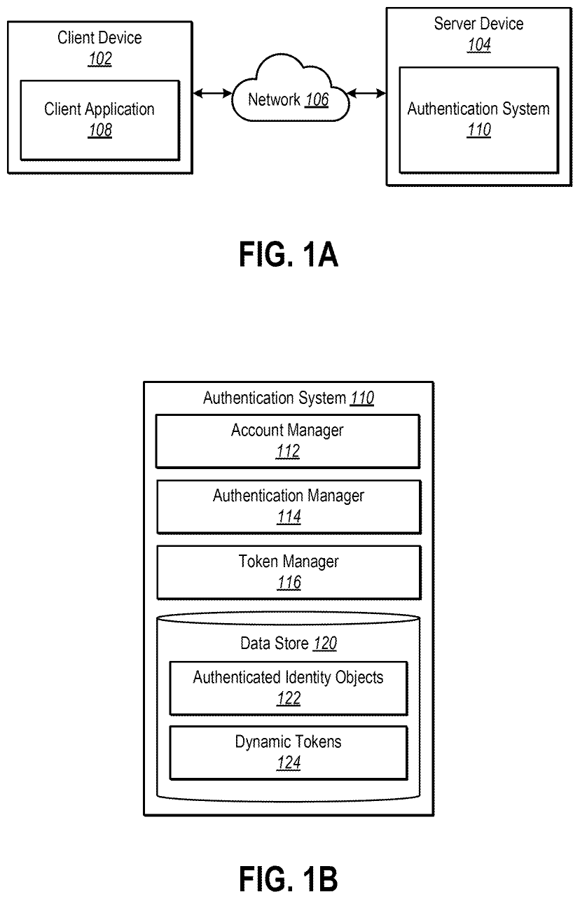

FIG. 1A illustrates an example environment 100 in which an authentication system 110 is implemented in accordance with one or more embodiments described herein. As shown in FIG. 1A, the environment 100 includes a server device 104. The server device 104 may include one or more computing devices (e.g., including processing units, data storage, etc.) organized in an architecture with various network interfaces for connecting to and providing data management and distribution across one or more client systems. As shown in FIG. 1A, the server device 104 may be connected to and may communicate with (either directly or indirectly) a client device 102 through a network 106. The network 106 may include one or multiple networks and may use one or more communication platforms and/or technologies suitable for transmitting data. The network 106 may refer to any data link that enables transport of electronic data between devices of the environment 100. The network 106 may refer to a hardwired network, a wireless network, or a combination of a hardwired network and a wireless network. In one or more embodiments, the network 106 includes the internet and/or a cellular network. The network 106 may be configured to facilitate communication between the various computing devices of the environment 100 via any protocol, standard, or form of communication.

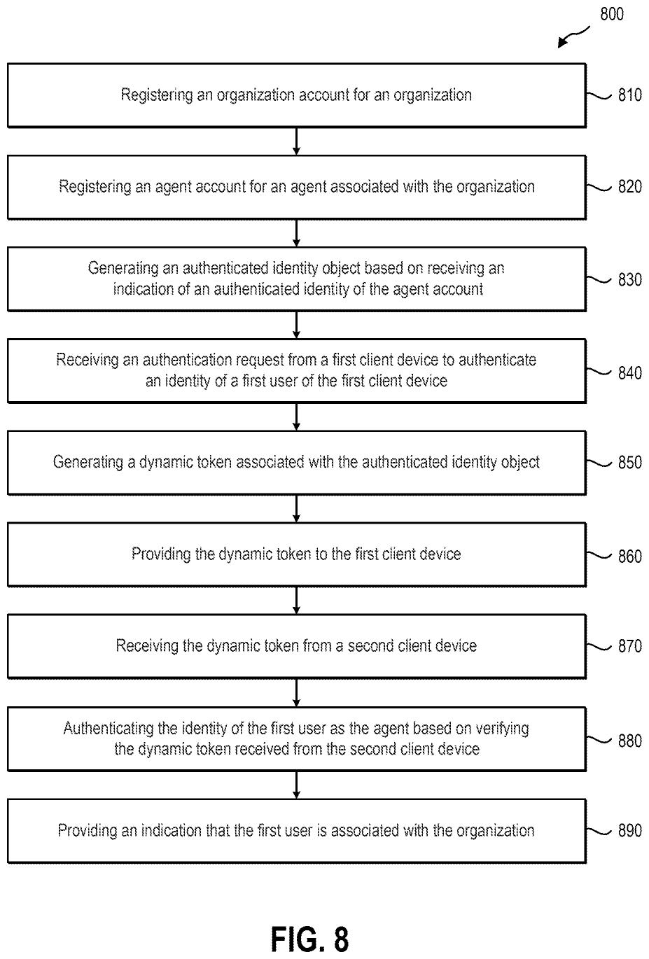

The client device 102 may be representative of one or multiple client devices, and may refer to various types of computing devices. For example, the client device 102 may include a mobile device such as a mobile telephone, a smartphone, a personal digital assistant (PDA), a tablet, a laptop, or any other portable device. Additionally, or alternatively, the client device 102 may include one or more non-mobile devices such as a desktop computer, server device, or other non-portable device. In one or more implementations, the client device 102 includes graphical user interfaces (GUI) thereon (e.g., a screen of a mobile device). In addition, or as an alternative, one or more of the client device 102 may be communicatively coupled (e.g., wired or wirelessly) to a display device having a graphical user interface thereon for providing a display of system content. The server device 104 may similarly refer to various types of computing devices. Each of the devices of the environment 100 may include features and/or functionalities described below in connection with FIG. 8.

As shown in FIG. 1A, the environment 100 may include an authentication system 110 implemented on the server device 104. While shown on the server device 104, the authentication system 110 may be implemented wholly or in part on the client device 102, across the server device 104 and the client device 102, or on or across one or more additional device, such that different portions or components of the authentication system 110 are implemented on different computing devices in the environment 100. The client device 102 may include a client application 108. The client application 108 may include an application or interface for interacting with and/or receiving the features of the authentication system 110 as described herein. In some embodiments, one or more of the functions or features of the authentication system 110 may be carried out or performed on or by the client application 108. In this way, the environment 100 may be a cloud computing environment, and the authentication system 110 may be implemented across one or more devices of the cloud computing environment.

FIG. 1B illustrates an example implementation of the authentication system 110 as described herein, according to at least one embodiment of the present disclosure. The authentication system 110 may include an account manager 112, an authentication manager 114, and a token manager 116. The authentication system 110 may also include a data storage 120 having authenticated identity objects 122 and dynamic tokens 124 stored thereon. While one or more embodiments described herein describe features and functionalities performed by specific components 112-116 of the authentication system 110, it will be appreciated that specific features described in connection with one component of the authentication system 110 may, in some examples, be performed by one or more of the other components of the authentication system 110.

By way of example, while user accounts may be created, registered, and maintained by the account manager 112, in some embodiments, these features may be delegated to other components of the authentication system 110. As another example, while dynamic tokens may be generated and transmitted by the token manager 116, in some instances, some or all of these features may be performed by the authentication manager 114 (or other component of the authentication system 110). Indeed, it will be appreciated that some or all of the specific components may be combined into other components and specific functions may be performed by one or across multiple components 112-116 of the authentication system 110.

Features and functionality of the authentication system 110 will be described with respect to several illustrative examples that may describe example applications and/or use cases of the authentication system 110. It should be understood that these examples are illustrative and are not meant to limit the applications and/or use cases of the authentication system to only those described herein. Indeed, the authentication system 110 may be implemented by combining features of multiple of the illustrative examples, and may be implemented in applications beyond that explicitly described herein.

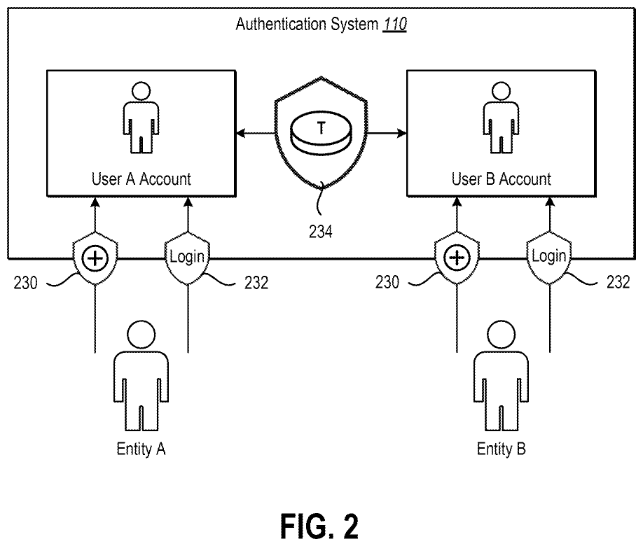

Turning now to FIG. 2, this figure illustrates an overview of the authentication system 110 providing multi-way authentication of users, according to at least one embodiment of the present disclosure. For example, FIG. 2 shows an entity A and an entity B. Entity A and entity B may intend to interact in the real world, and the authentication system 110 may provide multiple forms of authentication of each entity, both to the authentication system 110 itself, and to the other entity. In this way, the authentication system 110 may be implemented to ensure to each entity that the other entity is who they purport to be.

For example, the authentication system 110 may authenticate each entity by creating and maintaining, at 230, user accounts for each entity. User accounts may be created by receiving and verifying various information about each entity, and may periodically be maintained by receiving new, updated, or additional information about each entity. The authentication system 110 may initially and periodically verify this information in order to ensure that each user account is actually associated with the entity with which the user account claims to be associated.

The authentication system 110 may provide another layer of authentication of each entity upon login of each entity to their user account. For example, in order to access a user account, the authentication system 110 may implement a secure login, at 232. In this way, the authentication system 110 may not only verify that a user account is actually associated with the entity with which is purports to be associated, but the authentication system 110 may also verify that any login to the user account is actually performed by that specific entity. In this manner, the authentication system 110 may ensure, with a high confidence, that the users of each user account of the authentication system 110 are actually who they claim to be.

The authentication system 110 may provide a further layer of authentication by verifying specific interactions between entities and/or user accounts. For example, before interacting in the real world, the entities may interact, at 234, through their user accounts in the authentication system 110. As described herein, user accounts may call upon authenticated identity objects for validating these real-world interactions.

By authenticating and continually verifying that each user account is actually associated with a claimed entity, by only allowing that specific entity access to the user account, and by authenticating specific interactions between entities, the authentication system 110 may provide multiple forms of authentication in order that entities may interact in the real world securely and with a high confidence.

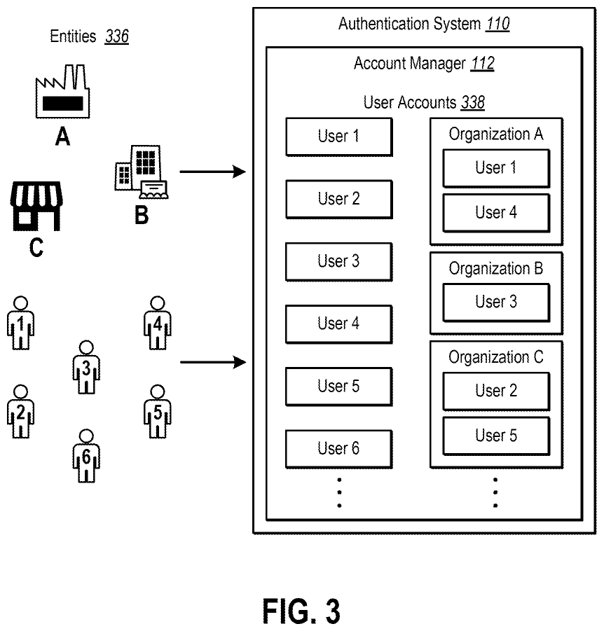

As mentioned above, the authentication system 110 includes an account manager 112. FIG. 3 illustrates example features of the account manager 112 as described herein, according to at least one embodiment of the present disclosure. The account manager 112 may register various entities 336 by creating user accounts 338 for each entity. The account manager 112 may register user accounts 338 for organizations and for individual users. Organizations may be any organization such as any companies providing products and/or services, government organizations, financial institutions, non-profit organizations, religious organizations, or any other grouping of people whether formally recognized or identified as an organization or not. Users may be singular individuals and/or in some cases may be (e.g., smaller) groupings or organizations of people such as family units, for which only one user account is needed or desired. Organizations may include and/or may be associated with one or more user accounts of individuals. In this example, the entities 336 include organizations A, B, and C, as well as users (e.g., individuals) 1-6. In some embodiments, organizations may include and/or may be associated with one or more user accounts of other organizations. The association or inclusion of a user account (whether individual or organization) with another user account may facilitate the sharing of authenticated identity objects between the associated user accounts as described herein. For example, individuals associated within an organization may more easily authenticate interactions with other individuals associated with another organizations based on authenticated identity objects established between the organizations, as described herein.

As mentioned above, the account manager 112 may collect user information in order to verify the user accounts 338. The account manager 112 may verify the entities in this way initially upon creation of the user accounts 338, and may periodically collect new and/or updated user information in order to continually verify the entities and their associated user accounts. For example, the user information may include information such as a name, address, photo, social security or tax-ID number, employment information, banking information, education information, past and/or present residence information (e.g., utilities bills, delivered mail), familial relationships, government-issued identification information, or any other information about the entity. In some embodiments, organizations may be verified and/or vetted with a state business license or registration of the organization, a website of the organization, a DUNS number of the organization, etc. The account manager 112 may verify this information against one or more public and/or private databases. In this way the account manager 112 may authenticate that, for example, an entity attempting to create and maintain a user account for organization A is actually organization A (e.g., and not some bad or fraudulent actor).

In some embodiments, organizations may be structured with various entities (e.g., individuals) pertaining or belonging to (e.g., employed by) the organization. For example, FIG. 3 shows users 1 and 4 as belonging to organization A, user 3 belonging to organization B, etc. The association of a user account with an organization may be in addition to the (e.g., standalone) user account in one or more other capacities irrespective of the organization. For instance, users 1-6 may have individual user accounts 338 which may serve for personal or other uses in addition to the association of their user account with a given organization.

The association of a user account with an organization may be a form of user information for use in verifying a user account as described above. For example, an administrator of a user account for an organization may acknowledge that the individual/user account is a part of the organization by verifying that the user account has a registered email with the same domain as the organization. The administrator may verify the association of the user account with the organization, for example independently or through some other real world means, such as a personal knowledge of the individual. Additionally, the association of a user account with an organization may be associated with the creation of an authenticated identify object between the user account and the organization as described in detail below. For example, an authenticated identity object for the individual-organization relationship may be created in connection with adding the user account to the organization such that the individual may call upon the authenticated identity object in order to act in their capacity as an employee or agent of the organization, as described herein.

In some embodiments, the account manager 112 may facilitate the entities 336 logging in to the user accounts 338 through secure logins. For example, a secure login may include a user providing one or more passwords or other information for logging into a user account. In some embodiments, the account manager 112 may implement multi-factor authentication of an entity for securely logging into a user account. In one particular example, the account manager 112 may facilitate secure logins by confirming biometric information of an entity attempting to login, as well as a password or passphrase. In some embodiments, the account manager 112 will only accept a login made from a device registered or associated with the user account. In some embodiments, the account manager 112 may implement a timeout threshold for automatically logging users out of user accounts such that users may periodically have to provide biometric and/or password information on their registered device in order to access their user account, further ensuring that only the associated users are accessing the user accounts. In this way the account manager 112 may ensure that a login to a user account may only be accomplished by the actual entity with which the account is associated. For example, if a password is leaked or stolen, a fraudulent actor may not be able to gain access to a user account without having physical access to the entities registered device and/or without having the biometric information of the entity.

As described herein, authenticated identity objects may be generated for representing known and/or trusted identities between entities (e.g., in the real world). The account manager 112 may facilitate storing, saving, or otherwise associating authenticated identity objects with the user accounts to which they pertain. In some embodiments, the account manager 112 may facilitate updating, adding, removing, canceling, and/or limiting accessing of a user to an authenticated identity object. For example, as described herein, authenticated identity objects may be shared (e.g., temporarily) between users in order to authenticate an interaction between entities that would otherwise not be able to be verifiable.

In some embodiments, the account manager 112 may maintain an authentication history of each user account. For example, the account manager 112 may identify and record each time a user account is authenticated (e.g., successfully shares a dynamic token as described herein). User accounts with longer and/or more robust (e.g., authenticated by many other user accounts) authentication history may be more trustworthy or reliable for other users of the authentication system 110. In some embodiments, the authentication history many include an authentication rating of the user account. For example, some user accounts may be more trusted or authenticated user accounts, such as accounts pertaining to financial institutions, notaries, public offices, etc., or simply user accounts that have been well-established, well-vetted, or otherwise authenticated with a high confidence. Based on an entity performing one or more actions with respect to those (e.g., highly trusted) user accounts or otherwise interacting with the underlying trusted entity, a user account may become more authenticated, may contribute to a more robust authentication history, and/or may earn a higher authentication rating. For instance, an individual may provide identifying documentation to a public office, and the public office may indicate through the authentication system 110 the identity of the individual, which may raise the rating of the individual. In another example, when an individual secures and/or makes payments on a loan such as a mortgage, a financial institution may provide further verification for the individual's rating and/or history through the authentication system 110.

In this way, the authentication system 110 may provide various means for verifying the association of an entity with their user account, and may verify that anyone logged into a user account is actually that entity, which may provide confidence and reliability for the users of the authentication system 110.

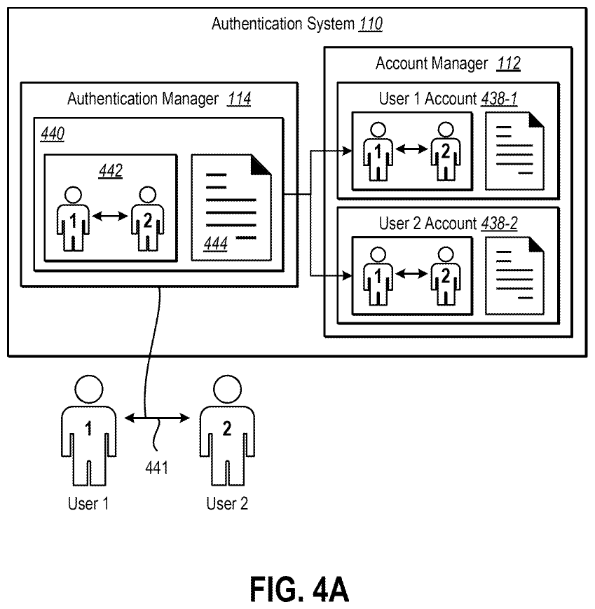

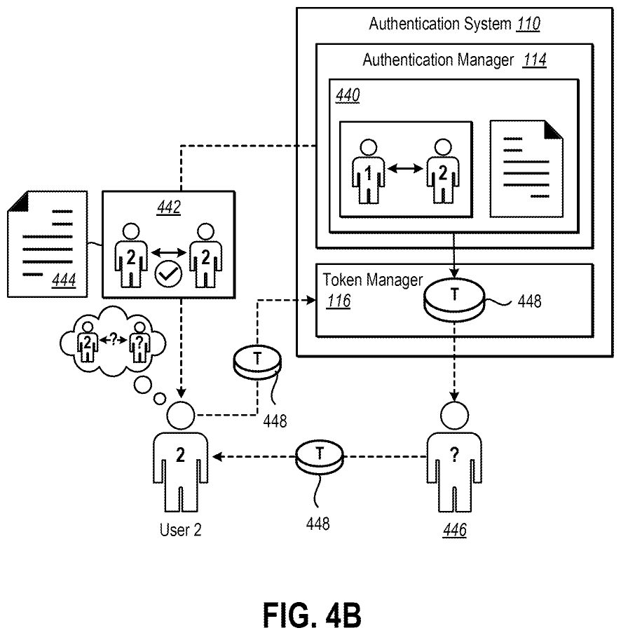

FIGS. 4A and 4B illustrate example implementations of the authentication system as described herein, according to embodiments of the present disclosure. The example implementations of FIGS. 4A and 4B are described with respect to a first individual, user 1, and a second individual, user 2. In some embodiments, a relationship, knowledge of, or mutual acquaintance between user 1 and user 2 may exist. For example, user 1 and user 2 may know each other, may be related, or may otherwise have a trusted relationship between themselves as individuals (e.g., irrespective of the authentication system 110), such as in the real world. For instance, user 1 and user 2 may be personal friends, may be work colleagues, may be non-personal acquaintances through a professional setting, may be trusted acquaintances through face-to-face and/or virtual interactions, or any number of other situations in which individuals may know and trust one another to various degrees. Thus, user 1 may have an authenticated identity 441 with respect to user 2 (and vice versa). The authentication system 110 may facilitate representing this mutual trust or authenticated identity 441 of users 1 and 2 through an authenticated identity object 440.

As described herein, the authenticated identity object 440 may be a data object that may record, memorialize, or otherwise represent the known identity of one user with respect to another. For example, the authenticated identity object 440 may include an indication of identity 442. The indication of identity (IOI) 442 may indicate that the corresponding entities are, in fact, associated in some way and have an established, authenticated identity, as represented by the authenticated identity object 440. For instance, the IOI 442 may be a Boolean that positively indicates an association between the users, and/or may indicated a type of association between the users. The authenticated identity object 440 may include (or may be associated with) identity information 444. The identity information 444 may include information related to the associated users/entities and the authenticated identity 441 between them. For instance, the identity information 444 may indicate the name, photo, contact information, etc. of one or more of the users. The identity information 444 may outline how the users know/trust each other, a level of trust or authority between the users, what tasks, objective, authority, or actions a user entrusts to another user, or any other details outlining the authenticated identity between the users. As an illustrative example, user 1 and user 2 may be personal friends, such as neighbors or relatives. The authenticated identity object 440 may indicate that the users have each recognized the other as a trusted friend (or relative), and may outline a degree of trust between the users, including specific tasks or duties that one party authorizes another to perform (e.g., as their proxy), etc.

In some embodiments, several authenticated identity objects may be generated for characterizing several authenticated identities between the users. For example, an authenticated identity object may be generated for representing a personal relationship between the users, and another authenticated identity object may be generated for representing user 1 in their capacity as an employee of user 2. In some embodiments, two or more authenticated identity objects may be generated for representing a single relationship or trusted association between users. For example, a first authenticated identity object may be generated outlining the authenticated identity of user 1 with respect to user 2, and a second authenticated identity object may be generated outlining the authenticated identity of user 2 with respect to user 1. In some embodiments, a single authenticated identity object may represent this (e.g., two-way) authenticated identity of users 1 and 2 in this way.

The authenticated identity object 440 may be stored, for example, on a server device, and may be associated with and/or accessible to a first user account 438-1 for user 1 and a second user account 438-2 for user 2. In this way, user 1 and/or user 2 may access or call upon the authenticated identity object 440 (through the user accounts), for example, for authenticating their identity to the other user as described herein. The authentication manager 114 may implement end-to-end encryption techniques for securely safeguarding authenticated identity objects during storage, transmission, and/or retrieval. For example, authenticated identity objects 440 may be stored in encrypted databases which may implement hashing or other encryption techniques for encoding and decoding the data of the authenticated identity objects. The authentication manager 114 may implement dynamic key management techniques for implementing and/or periodically updating one or more encryption keys for accessing authenticated identity objects. The authentication manager may administer an integrated, dispersed storage architecture for decentralizing data storage across multiple locations and/or device. The authentication manager 114 may implement techniques for preventing and detecting tampering and/or unauthorized access of authenticated identity objects. For example, the authentication manager 114 may implement blockchain or other similar decentralized-leger-type technologies for maintaining accurate, current data in a secure, tamper-proof format. Additionally, any of the security and/or encryption techniques described, for example, with respect to authenticated identity objects may be implemented with respect to passwords, personal information, dynamic tokens, or any other information or object of the authentication system 110.

In FIG. 4B, an unauthenticated user 446 may present themselves to user 2. The unauthenticated user 446 may be user 1, but may be unauthenticated in that user 2 has yet to authenticate, verify, or otherwise conclude that the unauthenticated user 446 is user 1. For example, the unauthenticated user 446 may claim to be user 1, but given certain circumstances, user 2 may not know, may not be certain, or otherwise may not be comfortable simply relying on the claim that the unauthenticated user 446 is user 1. For example, the unauthenticated user 446 may call or text user 2 claiming to be user 1 and asking to borrow money, asking for a ride, asking for access to a home or building, or any of a number of circumstances that may require a heightened level of sensitivity and/or suspicion. Accordingly, user 2 may not readily accept that the unauthenticated user 446 is user 1 and may prefer to authenticate the identity of the unauthenticated user 446.

In order to authenticate their identity as user 1, the unauthenticated user 446 may call upon the authenticated identity object 440 with a request to the authentication system 110. For example, the unauthenticated user 446 is user 1 (e.g., unbeknownst to user 2) and through their user account 438-1 has access to the authenticated identity object 440. In some embodiments, the authentication system 110 receives the request based on the unauthenticated user 446 logging in (e.g., securely as described herein) to their user account. For example, in one or more implementations, the request is received in response to the unauthenticated user 446 logging into their user account. Based on the unauthenticated user 446 having access to the authenticated identity object 440 (e.g., through their user account) the token manager 116 may generate a dynamic token 448. For example, the token manager 116 may access the authenticated identity object 440 and may generate an identifier, timestamp, and relative permissions for the token and may associate this information with the authenticated identify object 440. The dynamic token 448, when presented to the authentication system 110, may accordingly indicate an authenticated identity object with which it is linked.

The dynamic token 448 may be dynamic in that it may be an expiring or ephemeral token. For example, the dynamic token may be enabled to identify the authenticated identity object for a limited amount of time, such as 30 seconds, 60 seconds, or any other time threshold. The dynamic token 448 may be enabled for use by only select users, such as only users 1 and 2 in the case of the authenticated identity object 440 of the example implementation of FIG. 4B. The dynamic token 448 may be configured to only be enabled for a certain window of time (e.g., not presently, but some future window of time). The dynamic token 448 may be enabled for use by only a certain registered device, may be enabled within only a certain geofenced location (e.g., of a device), may be enabled only after certain conditions are met, or may be enabled according to any other dynamic scheme or criteria. The dynamic configuration of the dynamic token 448 may be specified by an associated user of a transaction of the dynamic token 448, or any other user with access to the authenticated identity object 440. For example, the configuration of the dynamic token 448 may be selected upon creation of the authenticated identity object 440, upon request of the token by one or more users, or at any other time. In this way, the authentication system 110 may generate a secure token for specifically identifying the authenticated identity object 440.

Upon request of the dynamic token 448, the token manager 116 may transmit the dynamic token 448 to the unauthenticated user 446. For example, the token manager 116 may transmit the dynamic token 448 to a client device of the unauthenticated user 446 through secure end-to-end encryption techniques. After receipt of the dynamic token 448, the unauthenticated user 446 may provide the dynamic token 448 to user 2. For instance, the unauthenticated user 446 may provide an alphanumeric code, password, etc. to user 2, who may then input the dynamic token 448 to their client device. As another example, the unauthenticated user 446 may transmit the dynamic token 448 to user 2, such as through a QR code, or other form of data transmission between client device. In this way, the dynamic token 448 may be shared between the users in any number of ways, such as through a dialogue between the users (e.g., face-to-face, telecommunication, messaging, etc.), a transmission between devices of the users, etc.

After receiving the dynamic token 448 (e.g., by receiving or inputting the dynamic token 448 to a client device), user 2 may provide the dynamic token 448 back to the authentication system 110 for authenticating the identity of the unauthenticated user 446. For instance, the token manager 116 may receive the dynamic token 448 from the client device of user 2 and may identify via the authentication manager 114 an authenticated identity object for which the dynamic token 448 is linked. In some embodiments, the token manager 116 may verify that the dynamic token 448 is the same dynamic token that was transmitted to the unauthenticated user 446. In some embodiments, the token manager 116 may verify that the criteria of the dynamic configuration of the dynamic token 448 are met, such as an expiring time threshold for the dynamic token 448.

Based on verifying the dynamic token 448 received from user 2, the authentication system 110 may provide various information to user 2 in order to authenticate the identity of the unauthenticated user 446 as user 1. In some embodiments, the authentication manager 114 may transmit some or all of the information associated with the authenticated identity object 440. For example, the authentication manager 114 may transmit the IOI 442 to user 2. The IOI 442 may be a Boolean (e.g., yes, checkmark, thumbs up, etc.) indicating that the unauthenticated user 446 is user 1. For instance, user 2 may submit a query or may populate an associated field in connection with providing the dynamic token 448 to the authentication system 11. The query may specify who the unauthenticated user 446 claims to be, with whom the unauthenticated user 446 purport to be associated, etc., and the authentication system 110 may provide information to user 2 in response to the query, such as the IOI 442, Boolean, or identity information 444). The IOI 442 may indicate more detailed information such as a specific type of relationship between the users. In another example, the authentication manager 114 may transmit some or all of the identity information 444 associated with the authenticated identity object 440, such as a name, photo, contact information, relation, etc. of user 1.

In some embodiments, the token manager 116 may not be able to verify the dynamic token 448. For example, the dynamic token 448 may be a fake, fraudulent, or otherwise invalid token. In another example, the dynamic token may be expired or may otherwise not satisfy one or more criteria for enabling the dynamic token 448. In such cases, the authentication manager 114 may indicate to user 2 that the dynamic token 448 could not be verified. For example, the authentication manager 114 may indicate to user 2 that the dynamic token 448 has expired, for example, and may indicate for a new dynamic token to be generated in order to authenticate the unauthenticated user 446. In another example, the authentication manager 114 may indicate that the dynamic token 448 is invalid and may, for example, indicate that the unauthenticated user 446 is not user 1, has provided a fraudulent token, and/or that user 2 should otherwise proceed with caution in their interactions with the unauthenticated user 446.

In some embodiments, the authentication system 110 may be implemented to authenticate the identity of each user with respect to the other. For example, the exchange of the dynamic token as described may be performed in both directions and/or with respect to both users, such as user 1 requesting and providing a first dynamic token to user 2 and user 2 requesting and proving a second dynamic token to user 1. The first and second dynamic tokens may each be linked to the same authenticated identity object or may be linked to different authenticated identity objects.

In this way, user 2 may authenticate that they are communicating and/or interacting with user 1 (and vice versa), based on the authenticated identity object 440 that has been created for the authenticated identity 441 between the users. The authentication system 110 may verify the identity of the unauthenticated user 446 as user 1 with a high confidence. For example, only user 1 and user 2 may have access to the authenticated identity object 440 for generating and/or receiving the dynamic token 448 such that a user in possession of the dynamic token 448 may confidently be presumed to be one of these two users. As another example, the transaction of the dynamic token 448 between user 1 and user 2 may only take place based on user 1 and user 2 securely logging into their respective user accounts, for example, by providing biometric information and/or a password on a specific registered device associate with their user account. As a further example, the user accounts for user 1 and user 2 may only be created based on information provided to and validated by the authentication system 110 to ensure that each user's account is actually associated with that user. In this way, the authentication system 110 may provide a means for individuals to securely and confidently interact with one another (e.g., face-to-face and/or virtual) with a reduced risk of fraud, deception, or misappropriation by one or more parties.

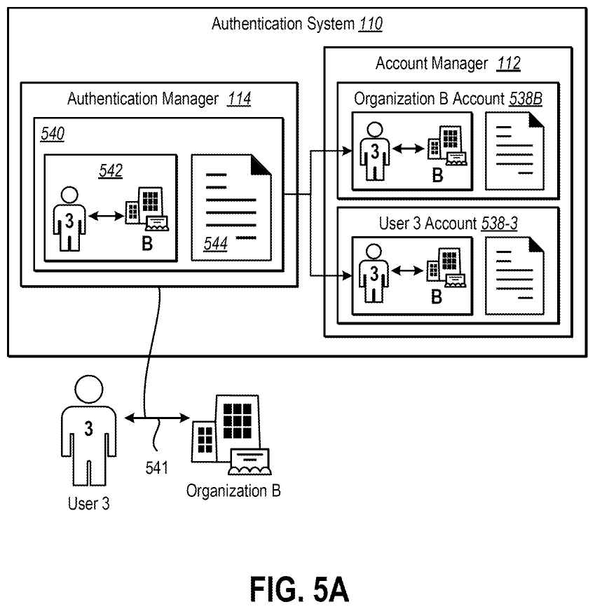

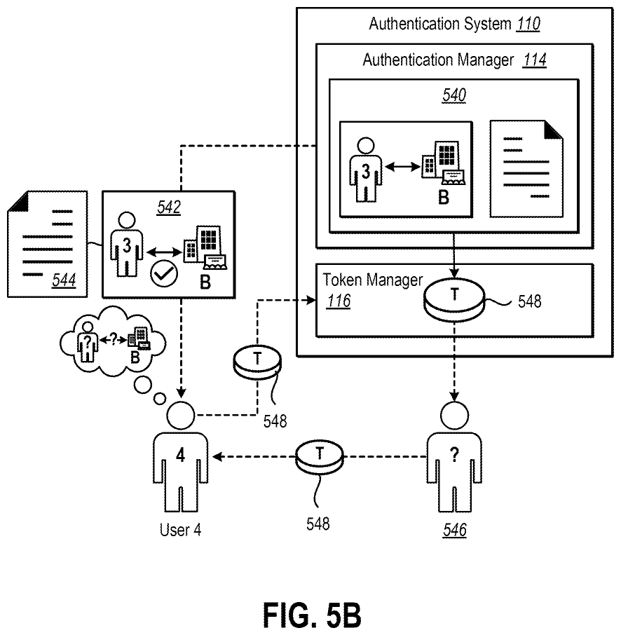

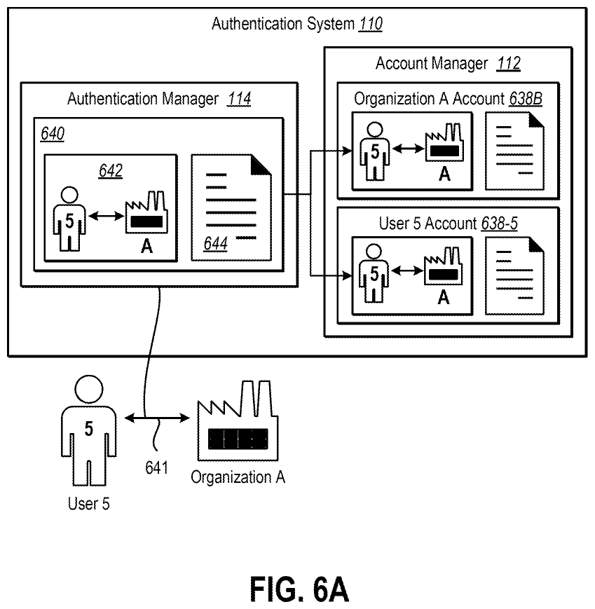

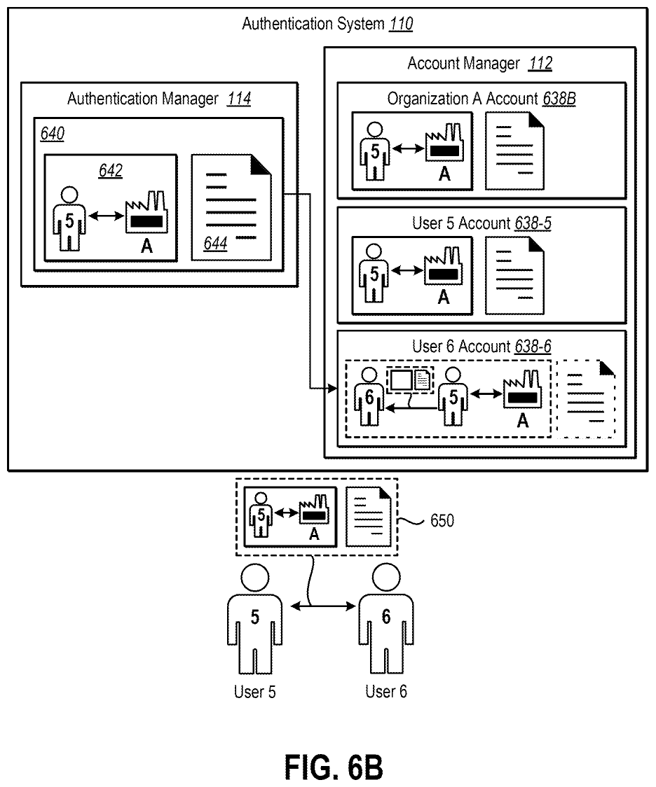

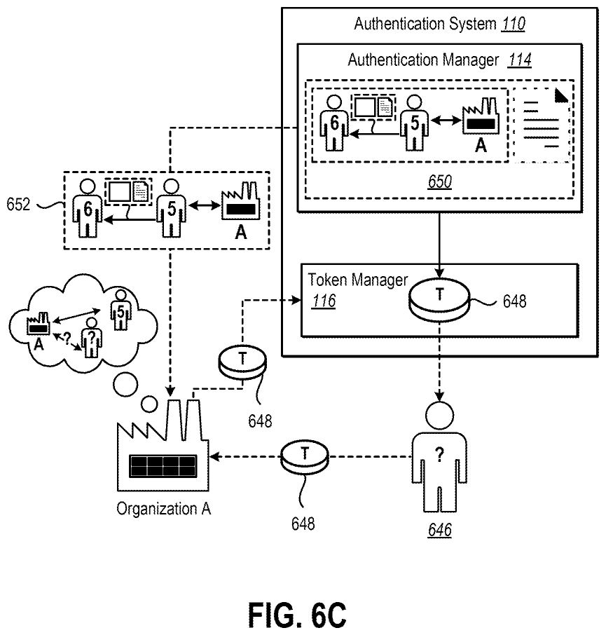

In some embodiments, the authentication system 110 may be utilized to provide some level of authentication between users without the use of an authenticated identity object between the users. For example, while it may be preferable to have pre-existing, trusted relationships with every individual (and/or organization) with which one interacts, in some embodiments individuals (and/or organizations) may interact for which no preexisting relationship exits, and accordingly for which no authenticated identity object exists. While one or more embodiments described herein describe how identities of such individuals may be authenticated, for example, through relationships of the individuals with a third party (e.g., FIGS. 5A-6C), in some embodiments it may be desirable to provide at least some level of authentication and/or identification based solely on an individual and their user account.

For example, suppose that homeowner receives a knock on their door from a visitor soliciting a product or service. The homeowner and the visitor have no preexisting relationship, and the homeowner has no knowledge or association with an organization that the visitor represents. Thus, in some cases there may not be an authenticated identity object that represents an established authenticated identity of either of the users upon which either can call in order to authenticate the identity of the other. Or, in another example, the visitor may have an authenticated identity object with an organization, but the homeowner may have no knowledge of, experience with, or relationship with the organization such that the visitor providing an indication of their authenticated identity with respect to the organization may do little to assure the homeowner of the visitor's identity. Nevertheless, it may be desirable for one or more of the users to receive at least some form of authentication of the other in order to initiate and/or continue an interaction with an increased level of confidence. In such a situation, one (or both) users may access their user account in order to authenticate their identity. For example, the visitor may provide an indication of their user account to the homeowner, such as by sharing a profile, account name, etc. or by exchanging a dynamic token. The visitor's account may provide verification to the homeowner that the visitor is and/or is associated with that which they claim (or conversely that they are not). For example, based on the vetting and authentication processes of each user account by the authentication system 110, as well as the secure login of the visitor to the visitor's user account, the homeowner may more confidently conclude the identity of the visitor as opposed to taking their word alone. Further, as described herein, each user account may be associated with an authentication history and/or an authentication rating. Based on a robust authentication history and/or a high authentication rating, the homeowner may authenticate the visitor with an even higher confidence. Thus, even without a pre-existing authenticated identity from which to base a more complete, secure authentication of an individual, the authentication system 110 may still provide an increased level of authentication for interactions between users. Additionally, an inability of one or more individuals (or organizations) to provide an indication of a user account and/or a negative or cautionary authentication history and/or rating may provide a warning to a user to avoid a potential interaction with another user.

FIGS. 5A and 5B illustrate example implementations of the authentication system as described herein, according to embodiments of the present disclosure. The example implementations of FIGS. 5A and 5B are described with respect to a third individual, user 3, an organization, organization B, and further with respect to a fourth individual, user 4.

In some embodiments, organization B may be a business or company that provides products or services to customers. In an example, organization B may be an internet service provider. User 3 may be an employee, agent, or contractor of organization B, or may otherwise be associated with organization B. In an example, user 3 may be a technician for an internet service provider. Thus, user 3 may have an authenticated identity 541 with respect to organization B (and/or vice versa). The authentication system 110 may facilitate representing the association of user 3 with organization B (e.g., authenticated identity 541) through an authenticated identity object 540.

The authentication manager 114 may generate the authenticated identity object 540. As described herein, the authenticated identity object 540 may include an IOI 542 indicating the authenticated identity 541. The authenticated identity object 540 may also include identity information 544 including more detailed information about the associated identity and relationship between user 3 and organization B. The authentication system 110 may associate the authenticated identity object 540 with a user account for organization B, 538B, as well as with a user account for user 3, 538-3. In this way, each of user 3 and organization B may access or call on the authenticated identity object 540 in order to provide authentication.

In FIG. 5B, an unauthenticated user 546 may present themselves to user 4. For example, user 4 may be a homeowner or business owner who has access to a home, business, or facility and which needs the services provided by organization B, such as internet services. The unauthenticated user 546 may present themselves to user 4 claiming to be user 3 and/or claiming to be a representative or associate of organization B. The unauthenticated user 546 may request access to the home or building of user 4 in order to perform internet service tasks. User 4, however, may be reluctant to grant access to the unauthenticated user 546. For example, user 4 may not know who user 3 is such that even if user 4 does assume that the unauthenticated user 546 is user 3, user 4 may still not be able to authenticate that user 3 is associated with organization B. For example, given that user 4 has no pre-existing relationship with user 3 (e.g., no authenticated identity object), user 4 cannot be certain that the unauthenticated user 546 is user 3 and is associated with organization B for providing, for example, the internet services of organization B.

In order to authenticate their identity to user 4, the unauthenticated user 546 may call upon the authenticate identity object 440 (e.g., associated with user 3 and organization B) with a request to the authentication system 110. Based on the unauthenticated user 546 having access to the authenticated identity object 540, the token manager 116 may generate a dynamic token 548 and may transmit the dynamic token 548 to the unauthenticated user 546. The unauthenticated user 546 may provide the dynamic token 548 to user 4 through any of the token transaction techniques described herein.

After receiving the dynamic token 548, user 4 may provide the dynamic token 548 back to the authentication system 110 for authenticating the identity of the unauthenticated user 546. For instance, the token manager 116 may receive the dynamic token 548 from the client device of user 4 and may identify via the authentication manager 114 the authenticated identity object 540 for which the dynamic token 548 is linked. The authentication system 110 may accordingly provide various information to user 4 in order to authenticate the identity of the unauthenticated user 546 as user 3. For example, the authentication manager may provide the IOI 542 for affirming the purported identity of the unauthenticated user 546 as user 3. Additionally, the authentication system 110 may provide some or all of the identity information 544 to user 4. For example, the identity information 544 may provide user 4 with a name, photo, contact information, etc. of user 3 to provide further resources for user 4 for verifying that the unauthenticated user 546 is user 3. For example, user 4 may verify some or all of this information in person against the unauthenticated user 546. The identity information 544 may further inform user 4 regarding the job authorities or permissions that user 3 has with respect to organization B, such as a task or job that user 3 is authorized to perform, warrantees or guarantees user 3 is authorized to make on behalf of organization B, qualifications or certifications that user 3 has, etc.

In this way, the identity of the unauthenticated user 546 may be verified as user 3, and user 4 may rely on this identity of user 3 with confidence. For example, based on a level of trust or confidence that user 4 has with respect to organization B (and the user account 538B of organization B), user 4 may rely on the authenticated identity 541 of user 3 recognized by organization B through the authenticated identity object 540. User 4 may have a level of trust or reliance on the user account 538B of organization B based on the verifications and authentications that the authentication system 110 performs with respect to each user account. For example, user 4 may trust that organization B and the user account 538B are legitimate and are actually who they claim to be based on the vetting process of the authentication system 110 described herein and/or based on the secure login techniques. Additionally, in some embodiments, user 4 and organization B may have previously established an authenticated identity and associated authenticated identity object between them. User 4 and organization B may utilize that authenticated identity object in their interactions, for example, for purchasing products or requesting services such that user 4 can further rely on the authentication of user 3 based on the authenticated identity object 540 between user 3 and organization B. In this way, the authentication system 110 may be implemented to authenticate the identity of an entity to a user by utilizing an authenticated identity object associated with a third party.

FIGS. 6A, 6B, and 6C illustrate example implementations of the authentication system as described herein, according to embodiments of the present disclosure. The example implementations of FIGS. 6A-6C are described with respect to a fifth individual, user 5, an organization, organization A, and a sixth individual, user 6.

In some embodiments, organization A may be a business or company that provides products or services to customers. In an example, organization B is a trade service company such as a plumber, electrician, handyman, etc. User 5 may be a homeowner in need of the services provided by organization A, and may solicit, schedule, or otherwise request for organization A to come to their home to provide the services. This request may establish an authenticated identity 641 of user 5 with respect to organization A (and vice versa), and the authentication system 110 may be implemented to represent this authenticated identity 641 via an authenticated identity object 640.

The authentication manager 114 may generate the authenticated identity object 640 which, as described herein, may include and IOI 642 indicating the authenticated identity 641 between user 5 and organization A. The authenticated identity object 640 may also include identity information 644 including more detailed information about the associated identity and relationship between user 5 and organization A, such as details concerning the requested services, price estimates, scheduling information, information about a technician to perform the services, etc. The authentication system 110 may associate the authenticated identity object 640 with a user account for organization A, 638A, as well as with a user account for user 5, 638-5. In this way, each of user 5 and organization A may access or call on the authenticated identity object 640 in order to identify user 5, organization A, the authenticated identity 641 (e.g., service request), etc.

FIG. 6B illustrates an example scenario of user 5 with respect to user 6. User 5 and user 6 may have a trusted relationship. For example, user 5 may be friends, neighbors, family members, or acquaintances. In some embodiments, user 5 and user 6 may have established an authenticated identity between them with an associated authenticated identity object as described herein. With respect to the services that organization A is to perform for user 5, in some cases, user 5 may be out of town, travelling, at work, or not able to be at home to interact with organization A. In such cases, it may be desirable for user 5 to authorize another individual, such as user 6 to act as their proxy, representative, or otherwise act in their place with regards to organization A. For instance, user 6 may be a neighbor who can be present at the home of user 5 to receive and interact with organization A at the home.

In some embodiments, user 5 may transfer, designate, or otherwise associate the authenticated identity object 640 with user 6 and their user account 638-6. For example, the authentication manager 114 may grant access of the authenticated identity object 640 to the user account 638-6. In some embodiments, access of the authenticated identity object 640 by the user account 638-6 may be limited, as represented by a limited authenticated identity object 650 generated or otherwise associated with the user account 638-6. For instance, user 6 may only access or call upon the limited authenticated identity object 650 for a limit amount (or window) of time, at a specific geofenced location, based on a (e.g., real time) authorization by user 5, or in any other limited capacity or limited configuration. The limited authenticated identity object 650 may include a limited IOI 652 indicating the transfer and associated authorization of user 5 to user 6. The limits of the limited authenticated identity object 650 may be set or configured by user 5, by user 6, by any other entity associated with the authenticated identity object 640 (e.g., company A), and combinations thereof. In some embodiments, user 5 may share the authenticated identity object 640 with user 6 fully or without any limitations. In this way, user 5 may share the authenticated identity object 640 (either entirely or in a limited capacity) for authenticating the identity of user 6 with respect to organization A.

In FIG. 6C, an unauthenticated user 646 may receive organization A (e.g., or a representative of organization A) at the home of user 5 and may present themselves as representing user 5 (e.g., as user 6). The unauthenticated user 646 may claim to have access to the home and/or may claim to have authority to make decisions, authorize repairs, etc., with respect to the service to be provided for user 5. Organization A, however, may not know, trust, or be able to verify that the unauthenticated user 646 is authorized to represent user 5. For example, even if organization A assumes the unauthenticated user 646 is user 6 as they purport to be, organization A may have no knowledge or trust of user 6 such that they may still not be able to verify that the unauthenticated user 646 is authorized to act in place of user 5.

In order to authenticate their identity to organization A, the unauthenticated user 646 may call upon the limited authenticated identity object 650 (and/or the authenticated identity object 640 depending on what user 5 shared with user 6) with a request to the authentication system 110. Based on the unauthenticated user 646 having access to the limited authenticated identity object 650, the token manager 116 may generate a dynamic token 648 and may transmit the dynamic token 648 to the unauthenticated user 646. The unauthenticated user 646 may provide the dynamic token 648 to organization A through any of the token transaction techniques described herein.

After receiving the dynamic token 648, organization A may provide the dynamic token 548 back to the authentication system 110 for authenticating the identity of the unauthenticated user 646. For instance, the token manager 116 may receive the dynamic token 648 from the client device of organization A and may identify via the authentication manager 114 the authenticated identity object 640 or limited authenticated identity object 650 for which the dynamic token 648 is linked. The authentication system 110 may accordingly provide various information to organization A in order to authenticate the identity of the unauthenticated user 646 as user 6 and as authorized to act for user 5. For example, the authentication manager may provide the limited IOI 652 for indicating that user 5 shared the authenticated identity object 640 to user 6 for authorizing user 6 to represent them. Additionally, the authentication system 110 may provide some or all of the associated identity information to organization A for aid in organization A further verifying the unauthenticated user 646 as user 6 and as a representative of user 5.

Accordingly, the identity (and authorization) of the unauthenticated user 646 may be confirmed to organization A in order that user 6 may act for user 5 and accommodate user 5 not being available for receiving and/or interacting with organization A. In this way, the authentication system 110 may be implemented to facilitate sharing an authenticated identity object between users (e.g., entities) in order to authenticate a user to a third party with which the user may not have an established association. Authenticated identity objects may be shared in this way between any entities, such as between organizations, or from an organization to an individual (e.g., employee, agent) of the organization. For example, and authenticated identity object may be created for an authenticated identity between two organizations, and the organizations may each share (e.g., access to) the authenticated identity object to one or more employees to facilitate members of each organization interacting securely on behalf of the organizations. In this way, sharing of (e.g., a single) authenticated identity object (e.g., associated with two organizations) may facilitate authenticating interactions between many different entities without having to establish authenticated identities and/or create authenticated identity objects for each interaction of an entity.

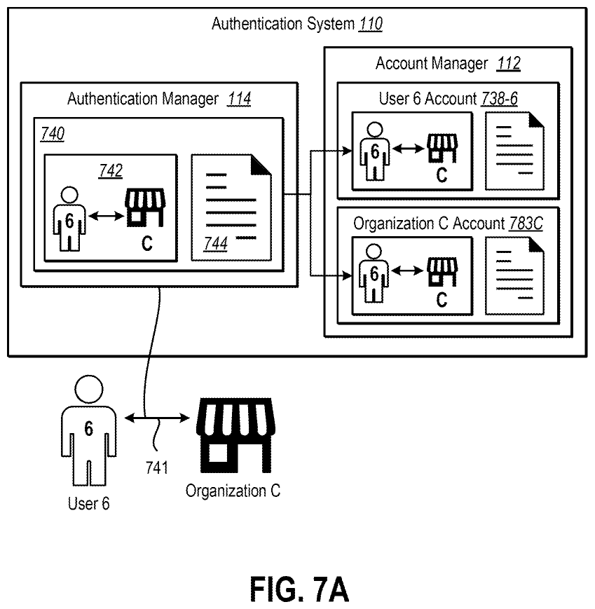

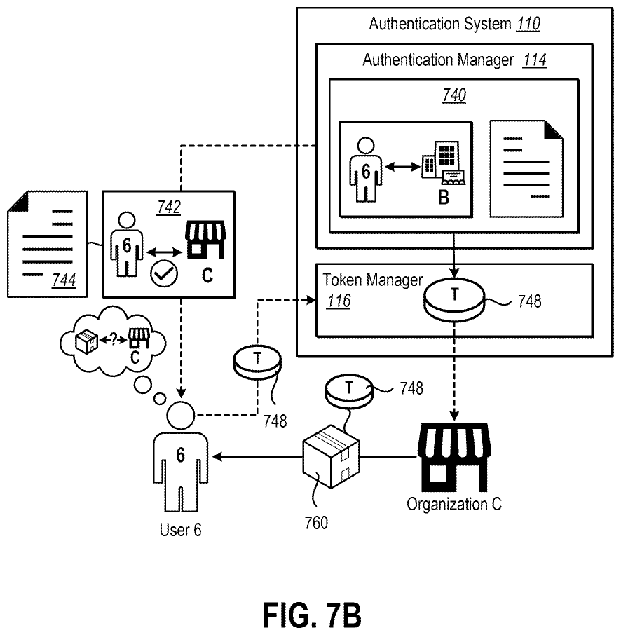

FIGS. 7A and 7B illustrate example implementations of the authentication system as described herein, according to embodiments of the present disclosure. The example implementations of FIGS. 7A and 7B are described with respect to a sixth individual, user 6, and an organization, organization C.

Organization C may be any organization as described herein. In one particular example, organization C may be a vendor or store that sells products to customers. In some embodiments, organization C may ship or deliver products to customers. For example, user 6 may be a customer of organization C, and may purchase a product from organization C for shipment to user 6. In some embodiments, user 6 and organization C may establish an authenticated identity 741 (e.g., based on a purchase) representing the relationship of user 6 as a customer of organization C, representing the purchase and/or product to be delivered to user 6 from organization C, etc., and the authentication system 110 may be implemented to represent this authenticated identity 741 via an authenticated identity object 740.

The authentication manager 114 may generate the authenticated identity object 740 which, as described herein, may include and IOI 742 indicating the authenticated identity 741 between user 6 and organization C. The authenticated identity object 740 may also include identity information 744 including more detailed information about the associated identity and relationship between user 6 and organization C. For example, the identity information 744 may include details such as a purchase invoice or agreement, information associated with the product to be delivered, a photo of the product and/or packaging, a carrier to deliver the product, contact information for organization C, etc. The authentication system 110 may associate the authenticated identity object 640 with a user account for organization C, 738C, as well as with a user account for user 6, 738-6. In this way, each of user 6 and organization C may access or call on the authenticated identity object 640 in order to identify user 6, organization C, the authenticated identity 741 (e.g., product purchase), etc.

In FIG. 7B, organization C may prepare and send a shipment 760 of the purchased product to user 6. User, 6 may receive the shipment 760 but may be unaware of its origin, may not have knowledge of the shipment, or may otherwise be unable to authenticate that the shipment 760 is associated with organization C and/or the product purchased from organization C. In order to provide a means for authenticating the shipment 760, organization C may call upon the authenticated identity object 740 with a request to the authentication system 110. Based on organization C having access to the authenticated identity object 740, the token manager 116 may generate a dynamic token 748 and may transmit the dynamic token 748 to the organization C. Organization C may provide the dynamic token 748 to user 6. For example, organization C may provide the dynamic token 748 to user 6 through any of the token transaction techniques described herein. In some examples, organization C may affix the dynamic token 748 to, or may include the dynamic token 748 in, the shipment 760. For instance, an identifier of the dynamic token 748 such as an alphanumeric code or QR code may be printed on a label of the shipment 760, or may be included within a packaging of the shipment. The dynamic token 748 may be expiring or ephemeral such that the dynamic token 748 is only active for a certain duration of time. In some embodiments, the dynamic token 748 may be configured to only be enabled at a certain time or for a certain time window, for example, corresponding with an estimated time in which user 6 will take delivery of the shipment 760. In some embodiments, the dynamic token 748 may be configured to only be enabled for a geofenced area corresponding to a location in which user 6 may take delivery of the shipment 760. In this way, the features and functionality of dynamic tokens described herein may be applicable to the dynamic token 748, for example, despite the dynamic token 748 being a physical and/or printed dynamic token that may not be capable of changing and/or updating.

After receiving the dynamic token 748 (e.g., via the shipment 760) user 6 may provide the dynamic token 748 back to the authentication system 110 for authenticating the shipment 760 as pertaining to or originating from organization C. For instance, the token manager 116 may receive the dynamic token 748 from the client device of user 6 and may identify via the authentication manager 114 the authenticated identity object 740 for which the dynamic token 748 is linked. The authentication system 110 may accordingly provide various information to user 6 in order to authenticate the shipment 760 as being associated with organization C. For example, the authentication manager may provide the IOI 742 for affirming the origin of the shipment 760. Additionally, the authentication system 110 may provide some or all of the identity information 744 to user 6. For example, the identity information 744 may provide user 6 with a photo of the shipment 760 as prepared by organization C, may indicate a carrier or delivery service from which user 6 is to take possession of the shipment 760, or any other information which may further aid user 6 in authenticating the shipment 760 as being associated with organization C.

Accordingly, the identity and/or origin of the shipment 760 may be confirmed by user 6 as pertaining to organization C in order that user 6 may rely on the shipment and/or its contents, for example, as fulfilling the purchase of the product from organization C. In this way, the authentication system 110 may be implemented to facilitate the exchange of goods, services, information, payments, etc. between entities based on an authenticated identity and associated authenticated identity object between the entities. For example, based on only user 6 and organization C having access to the authenticated identity object 740, user 6 can be certain with a high degree of confidence that the shipment 760 is from organization C, and that the shipment is not, for example, a harmful, damaging, false, or otherwise fraudulent shipment from a bad actor purporting to be organization C. Additionally, based on the identity information 744 provided to user 6 by the authentication system 110, user 6 may further be able to verify that the shipment 760 has not been maliciously intercepted, modified, or changed in some harmful or damaging way.

The embodiments and illustrative examples described herein are intended to be exemplary of features, functionalities, and implementations of the authentication system 110, and the authentication system 110 should not be understood as limited to only these embodiments and applications. Rather, it should be understood that the techniques described herein with respect to the exemplary embodiments may be applicable and advantageous in many (or any) application in which the identity, relationship, or association between entities may be authenticated. For example, any interaction between any two entities may be facilitated by the techniques described with respect to FIGS. 4A and 4B. Further, any entity associated with and/or acting on behalf of another entity may be facilitated by the techniques described with respect to FIGS. 5A-6C. Moreover, the transaction of goods, the transaction of information, the issuing or completion of payments, the execution and/or performance of contracts, or any other application in which objects or information, whether tangible or virtual, may be exchanged between any entities may be facilitated by the techniques descried with respect to FIGS. 7A and 7B. Indeed, any of the features described herein may be combined with any other feature described herein notwithstanding an exemplary figure or implementation with which a feature is described. In this way, the identity authentication techniques described herein may provide an increased level of authentication and identification for entities interacting in various ways.

Additionally, in some embodiments the techniques described herein may be implemented through the use of one or more models. For example, one or more models may be implemented for detecting inconsistencies, for detecting suspicious or fraudulent activity, for authentication in any of the manners discussed herein, for assessing risk, etc. In a particular example, models may be implemented for facilitating the vetting or verification of entities with respect to their user account, such as by verifying and/or cross-referencing personal information provided by a user or otherwise accessible to the authentication system. As another example, models may be implemented for inferring the validity of dynamic tokens provided to and/or by one or more users, such as by detecting suspicious activity of a user or a device, activity from a suspicious location or within a suspicious timeframe, etc. Models implemented for performing one or more functions may be static or dynamic models or algorithms. Models may incorporate machine learning and/or artificial intelligence, for example for learning signals and/or combinations of signals that are indicative of fraudulent activity, suspect circumstances, for vetting and/or confirming user accounts, etc. In this way, the authentication techniques described herein may be augmented through the use of one or more models.

FIG. 8 illustrates a method 800 or a series of acts for authenticating an individual as described herein, according to at least one embodiment of the present disclosure. While FIG. 8 illustrates acts according to one embodiment, alternative embodiments may add to, omit, reorder, or modify any of the acts of FIG. 8.

In some embodiments, the method 800 includes an act 810 of registering, at a server device, an organization account for an organization.

In some embodiments, the method 800 includes an act 820 of registering, at the server device, an agent account for an agent associated with the organization.

In some embodiments, the method 800 includes an act 830 of generating an authenticated identity object based on receiving an indication of an authenticated identity of the agent account. For example, the indication may be received from the organization account. In some embodiments, the authenticated identity object is maintained in a storage accessible to the server device. In some embodiments, receiving the indication of the authenticated identity is based on a secure login of the organization to the organization account and based on a secure login of the agent to the agent account, and wherein receiving the indication includes receiving, from the organization account, an indication of a trusted relationship between the organization and the agent. In some embodiments, creating the authenticated identity object includes receiving identity information associated with the agent and associating the identity information with the authenticated identity object. For example, the identity information may include one or more of a name of the agent, a photo associated with the agent, contact information of the agent, employment information of the agent, a task of the agent, permissions of the agent, an authentication history of the agent, or an authentication rating of the agent. In some embodiments, the authenticated identity object maintained in storage is encrypted.

In some embodiments, the method 800 includes an act 840 of receiving an authentication request from a first client device to authenticate an identity of a first user of the first client device with respect to the organization. For example, receiving the authentication request may be based on a secure login of the first user to the agent account. The secure login may be based on the first user providing a password and one or more biometrics on an associated client device.

In some embodiments, the method 800 includes an act 850 of generating, based on the authentication request, a dynamic token associated with the authenticated identity object. For example, the dynamic token may include one or more of a quick read code, an alphanumeric code, a password, or a passphrase. In some embodiments, generating the dynamic token includes generating a time threshold for the dynamic token to expire.

In some embodiments, the method 800 includes an act 860 of providing the dynamic token to the first client device. In some embodiments, the dynamic token is transmitted to the first client device through end-to-end encrypted communication to the first client device,

In some embodiments, the method 800 includes an act 870 of receiving the dynamic token from a second client device, the dynamic token having been received by a second user of the second client device from the first user. For example, receiving the dynamic token may be based on a secure login of the second user to a second user account. The secure login may be based on the second user providing a password and one or more biometrics on an associated client device. In some embodiments, receiving the dynamic token from the second client device includes receiving, from the second client device, an indication of the organization to which the dynamic token and or the authenticated identity object pertains. In some embodiments, the dynamic token is received from the second client device through end-to-end encrypted communication from the second client device. In some embodiments, the second user receives the dynamic token through a dialogue between the first user and the second user including one or more of an in-person communication, a telecommunication, messaging, or email. In some embodiments, the second user receives the dynamic token through an interaction of the first user and the second user exchanging data through one or more of a quick read code, a bar code, a near-field communication, radio frequency identification, Bluetooth, or a data network. In some embodiments, receiving the dynamic token from the second client device is based on user input by the second user to the second client device.

In some embodiments, the method 800 includes an act 880 of authenticating the identity of the first user as the agent based on verifying that the dynamic token received from the second client device is associated with authenticated identity object maintained at the server device.

In some embodiments, the method 800 includes an act 890 of providing, to the second client device, an indication that the first user is associated with the organization. For example, providing the indication can include providing an indication that the first user is the agent. In some embodiments, at least some of the identity information associated with the authenticated identity object may be provided to the second client device.

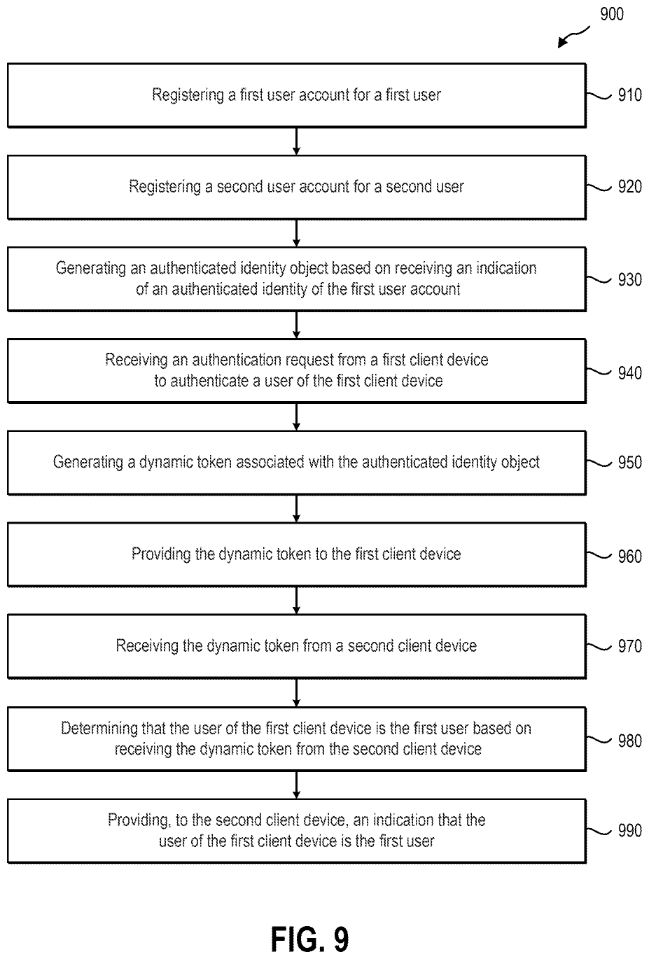

FIG. 9 illustrates a method 900 or a series of acts for authenticating an individual as described herein, according to at least one embodiment of the present disclosure. While FIG. 9 illustrates acts according to one embodiment, alternative embodiments may add to, omit, reorder, or modify any of the acts of FIG. 9.

In some embodiments, the method 900 includes an act 910 of registering, at a server device, a first user account for a first user.

In some embodiments, the method 900 includes an act 920 of registering, at the server device, a second user account for a second user.

In some embodiments, the method 900 includes an act 930 of generating an authenticated identity object based on receiving an indication of an authenticated identity of the first user account, in some embodiments, the authenticated identity object is maintained in a storage accessible to the server device.

In some embodiments, the method 900 includes an act 940 of receiving an authentication request from a first client device to authenticate an association of a user of the first client device with the second user. In some embodiments, the authentication request is received from the first user account on the first client device.

In some embodiments, the method 900 includes an act 950 of generating, based on the authentication request, a dynamic token associated with the authenticated identity object.

In some embodiments, the method 900 includes an act 960 of providing the dynamic token to the first client device.

In some embodiments, the method 900 includes an act 970 of receiving the dynamic token from a second client device, the dynamic token having been received by the second user from the user of the first client device.

In some embodiments, the method 900 includes an act 980 of determining that the user of the first client device is the first user based verifying that the dynamic token received from the second client device is associated with the authenticated identity object maintained at the server device.

In some embodiments, the method 900 includes an act 990 of providing, to the second client device, an indication that the user of the first client device is the first user.

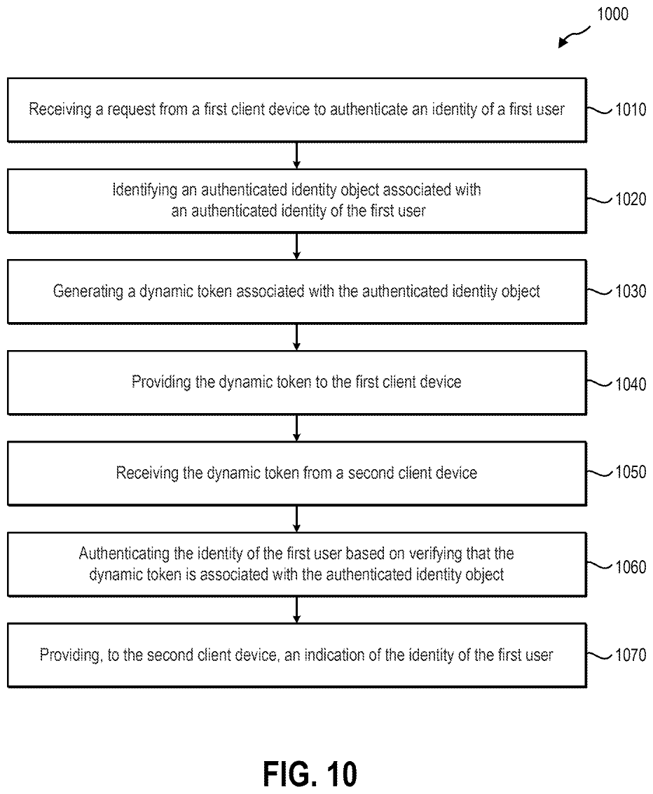

FIG. 10 illustrates a method 1000 or a series of acts for authenticating an individual as described herein, according to at least one embodiment of the present disclosure. While FIG. 10 illustrates acts according to one embodiment, alternative embodiments may add to, omit, reorder, or modify any of the acts of FIG. 10.

In some embodiments, the method 1000 includes an act 1010 of receiving, at a server device, a request from a first client device to authenticate an identity of a first user of the first client device with respect to a second user of a second client device.

In some embodiments, the method 1000 includes an act 1020 of identifying an authenticated identity object associated with an authenticated identity of the first user with respect to the second user, wherein the authenticated identity object is maintained in a storage accessible to the server device.

In some embodiments, the method 1000 includes an act 1030 of generating, based on the request, a dynamic token associated with the authenticated identity object.

In some embodiments, the method 1000 includes an act 1040 of providing the dynamic token to the first client device.

In some embodiments, the method 1000 includes an act 1050 of receiving the dynamic token from a second client device based on user input by a second user to the second client device, the dynamic token having been received by the second user from the first user.

In some embodiments, the method 1000 includes an act 1060 of authenticating the identity of the first user with respect to the second user based on verifying that the dynamic token received from the second client device is associated with the authenticated identity object maintained at the server device.

In some embodiments, the method 1000 includes an act 1070 of providing, to the second client device, an indication of the identity of the first user.

In some embodiments, the method 1000 includes receiving a second request from the second client device to authenticate the identity of the first user. In some embodiments, the method 1000 includes generating, based on the second request, a second dynamic token associated with the authenticated identity object. In some embodiments, the method 1000 includes providing the second dynamic token to the second client device. In some embodiments, the method 1000 includes receiving the dynamic token from the first client device based on user input of the first user to the first client device, the second dynamic token having been received by the first user from the second user. In some embodiments, the method 1000 includes authenticating the identity of the second user with respect to the first user based on verifying that the second dynamic token received from the first user device is associated with the authenticated identity object maintained at the server device.

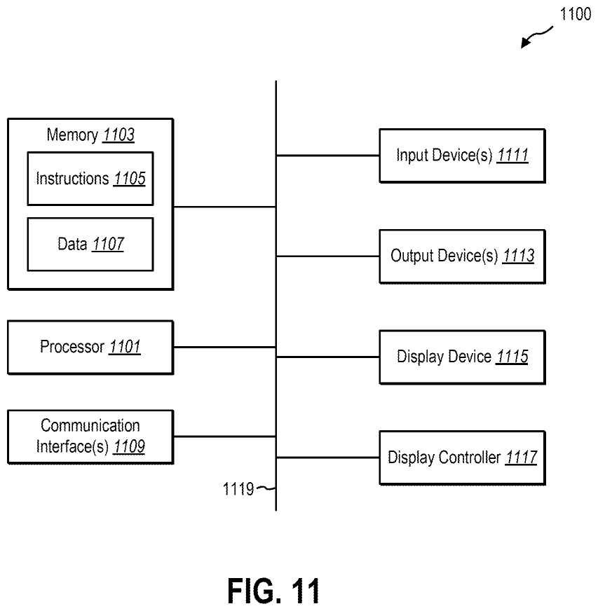

Turning now to FIG. 11, this figure illustrates certain components that may be included within a computer system 1100. One or more computer systems 1100 may be used to implement the various devices, components, and systems described herein.

The computer system 1100 includes a processor 1101. The processor 1101 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1101 may be referred to as a central processing unit (CPU). Although just a single processor 1101 is shown in the computer system 1100 of FIG. 11, in an alternative configuration, a combination of processors (e.g., an ARM and DSP) could be used.

The computer system 1100 also includes memory 1103 in electronic communication with the processor 1101. The memory 1103 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 1105 and data 1107 may be stored in the memory 1103. The instructions 1105 may be executable by the processor 1101 to implement some or all of the functionality disclosed herein. Executing the instructions 1105 may involve the use of the data 1107 that is stored in the memory 1103. Any of the various examples of modules and components described herein may be implemented, partially or wholly, as instructions 1105 stored in memory 1103 and executed by the processor 1101. Any of the various examples of data described herein may be among the data 1107 that is stored in memory 1103 and used during execution of the instructions 1105 by the processor 1101.

A computer system 1100 may also include one or more communication interfaces 1109 for communicating with other electronic devices. The communication interface(s) 1109 may be based on wired communication technology, wireless communication technology, or both. Some examples of communication interfaces 1109 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 1109 may connect the computer system 1100 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 1100 may also include one or more input devices 1111 and one or more output devices 1113. Some examples of input devices 1111 include a keyboard, mouse, microphone, remote control device, button, joystick, trackball, touchpad, and lightpen. Some examples of output devices 1113 include a speaker and a printer. One specific type of output device that is typically included in a computer system 1100 is a display device 1115. Display devices 1115 used with embodiments disclosed herein may utilize any suitable image projection technology, such as liquid crystal display (LCD), light-emitting diode (LED), gas plasma, electroluminescence, or the like. A display controller 1117 may also be provided, for converting data 1107 stored in the memory 1103 into one or more of text, graphics, or moving images (as appropriate) shown on the display device 1115.

The various components of the computer system 1100 may be coupled together by one or more buses, which may include one or more of a power bus, a control signal bus, a status signal bus, a data bus, other similar components, or combinations thereof. For the sake of clarity, the various buses are illustrated in FIG. 11 as a bus system 1119.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of authenticating an individual, comprising:
registering, at a server device, an organization account for an organization;
registering, at the server device, an agent account for an agent associated with the organization;
generating an authenticated identity object based on receiving an indication of an authenticated identity of the agent account from the organization account, wherein the authenticated identity object is maintained in a storage accessible to the server device;
receiving an authentication request from a first client device to authenticate an identity of a first user of the first client device with respect to the organization;
generating, based on the authentication request, a dynamic token associated with the authenticated identity object;
providing the dynamic token to the first client device;
receiving the dynamic token from a second client device, the dynamic token having been received by a second user of the second client device from the first user;
authenticating the identity of the first user as the agent based on verifying that the dynamic token received from the second client device is associated with the authenticated identity object maintained at the server device; and
providing, to the second client device, an indication that the first user is associated with the organization.

2. The method of claim 1, wherein providing the indication that the first user is associated with the organization includes providing, to the second client device, an indication that the first user is the agent.

3. The method of claim 1, wherein receiving the indication includes receiving, from the organization account, an indication of a trusted relationship between the organization and the agent.

4. The method of claim 1, wherein receiving the authentication request is based on a secure login of the first user to the agent account, and wherein receiving the dynamic token is based on a secure login of the second user to a second user account.

5. The method of claim 4, wherein the secure login of the agent account and of the second user account each includes an associated user providing a password and one or more biometrics on an associated client device.

6. The method of claim 1, wherein receiving the dynamic token from the second client device includes receiving, from the second client device, an indication of the organization.

7. The method of claim 1, wherein generating the authenticated identity object includes receiving identity information associated with the agent and associating the identity information with the authenticated identity object.

8. The method of claim 7, wherein the identity information includes one or more of a name of the agent, a photo associated with the agent, contact information of the agent, employment information of the agent, a task of the agent, permissions of the agent, an authentication history of the agent, or an authentication rating of the agent.

9. The method of claim 7, wherein providing the indication includes providing, to the second client device, a portion of the identity information associated with the authenticated identity object.

10. The method of claim 1, wherein the authenticated identity object maintained in the storage is encrypted.

11. The method of claim 1, wherein the dynamic token includes one or more of a quick read (QR) code, an alphanumeric code, a password, or a passphrase.

12. The method of claim 1, wherein generating the dynamic token includes determining a time threshold for the dynamic token to expire.

13. The method of claim 1, wherein providing the dynamic token to the first client device includes transmitting the dynamic token to the first client device through an end-to-end encrypted communication to the first client device, and receiving the dynamic token from the second client device includes receiving the dynamic token through an end-to-end encrypted communication from the second client device.

14. The method of claim 1, wherein the dynamic token is received by the second user from the first user through a dialogue between the first user and the second user including one or more of in-person communication, telecommunication, messaging, or email.

15. The method of claim 1, wherein the dynamic token is received by the second user from the first user through an interaction of the first user and the second user exchanging data through one or more of a QR code, a bar code, near-field communication (NFC), radio frequency identification (RFID), Bluetooth, or a data network.

16. The method of claim 1, wherein receiving the dynamic token from the second client device is based on user input by the second user to the second client device.

17. A method of authenticating an individual, comprising:
registering, at a server device, a first user account for a first user;
registering, at the server device, a second user account for a second user;
generating an authenticated identity object based on receiving an indication of an authenticated identity of the first user account; wherein the authenticated identity object is maintained in a storage accessible to the server device;
receiving an authentication request from a first client device to authenticate an association of a user of the first client device with the second user;
generating, based on the authentication request, a dynamic token associated with the authenticated identity object;
providing the dynamic token to the first client device;
receiving the dynamic token from a second client device, the dynamic token having been received by the second user from the user of the first client device;
determining that the user of the first client device is the first user based on verifying that the dynamic token received from the second client device is associated with the authenticated identity object maintained at the server device; and
providing, to the second client device, an indication that the user of the first client device is the first user.

18. The method of claim 17, wherein the authenticated identity object is accessible to only the first user and the second user.

19. A method of authenticating an individual, comprising:
receiving, at a server device, a request from a first client device to authenticate an identity of a first user of the first client device with respect to a second user of a second client device;
identifying an authenticated identity object associated with an authenticated identity of the first user with respect to the second user, wherein the authenticated identity object is maintained in a storage accessible to the server device;
generating, based on the request, a dynamic token associated with the authenticated identity object, providing the dynamic token to the first client device;
receiving the dynamic token from a second client device based on user input by a second user to the second client device, the dynamic token having been received by the second user from the first user;
authenticating the identity of the first user with respect to the second user based on verifying that the dynamic token received from the second client device is associated with the authenticated identity object maintained at the server device; and
providing, to the second client device, an indication of the identity of the first user.

20. The method of claim 19, further comprising:
receiving a second request from the second client device to authenticate the identity of the first user;
generating, based on the second request, a second dynamic token associated with the authenticated identity object;
providing the second dynamic token to the second client device;
receiving the dynamic token from the first client device based on user input of the first user to the first client device, the second dynamic token having been received by the first user from the second user;
authenticating the identity of the second user with respect to the first user based on verifying that the second dynamic token received from the first device is associated with the authenticated identity object maintained at the server device; and
providing, to the first client device, an indication of the identity of the second user.
